(19) United States
(12) Patent Application Publication
(10) Pub. No.: US 2010/0155609 A1
(43) Pub. Date: Jun. 24, 2010

(54) RADIATION DEVICE OR SIGNAL

(75) Inventor: Ronald Laksham Silva, Orpington (GB)

Correspondence Address: Buchanan Intellectual Property Office LLC, P.O. Box 700, Perrysburg, OH, 43552-0700, US

(73) Assignee: THE MEDWAY NHS TRUST, GILLINGTON (GB)

(21) Appl. No.: 12/440,774

(22) PCT Filed: Sep. 11, 2007
(86) PCT No.: PCT/GB07/03415

§ 371 Date: Jan. 6, 2010

(30) Foreign Application Priority Data
Sep. 11, 2006 (GB) 0617814.9
Sep. 11, 2007 (GB) PCT/GB2007/003415

(51) Int. Cl. G21K 1/00; G01T 1/161

(52) U.S. Cl. 250/363.06; 250/505.1

(57) ABSTRACT

A zoned radiation device for converging radiation of a wavelength λ to a focus at distance b, the device comprising a first set of zones and a second set of zones, wherein the first set of zones have a different characteristic to the second set and wherein the area of the zones decrease as their distance from a predetermined point increases, and one or more zone distances at which a zone of the first set with a first characteristic switches to a second zone with a second characteristic are configured such that the device can focus the radiation with wavelength λ at a distance b with an autocorrelation/point spread function that is sharper than the autocorrelation/point spread function produced by zones configured to a Fresnel zone construction.

This invention relates to zoned radiation devices and chirps or pulsed signals for, for example, imaging, converging, focussing, collimating, collecting, monochromaticizing radiation including electromagnetic radiation, acoustic radiation and thermal neutrons, or for use, for example, in radar, sonar, mobile radio or with multiple transmission, multiple receiving antenna sounders.

It is known to construct a zone plate using Fresnel's zone construction to form a so called “Fresnel zone plate”. A Fresnel zone plate consists of a set of radially symmetric annuli surrounding a circle, known as Fresnel zones. These alternate between opaque and transparent with respect to the radiation under study, and each of the zones is approximately equal in area.

Radiation of a certain wavelength which hits the zone plate will diffract around the opaque zones. Following the Fresnel construction the zones are spaced so that the diffracted radiation constructively interferes at a desired focus, creating an image at that focus. Accordingly a Fresnel zone plate can be used as a form of lens. The plate can produce an image, whether the central zone is opaque or transparent as long as the zones alternate in relative transparency. In practice each zone will produce a focus and therefore an image at that focus. In other words a series of foci and images are produced corresponding to each zone.

In Fresnel's zone construction this constructive interference at the desired focus is achieved by the phase of the diffracted radiation only. This is satisfied provided that the zone plate is evenly illuminated by the radiation, and the radiation is planar. Since each zone is approximately equal in area the diffracted waves, from a planar source, will be of approximately equal amplitude.

Such Fresnel zone plates can be manufactured by a number of conventional methods including lithography.

Fresnel zone plates are particularly suitable for focussing radiation, such as gamma rays or sound/acoustic radiation, which cannot be easily focussed by refractive lenses. Applications using such devices can be found in areas throughout the complete electromagnetic spectrum ranging from radio waves through to gamma rays.

As well as a standard Fresnel zone plate, it is known to produce so-called Fresnel phase zone plates where the opaque zones are replaced by zones that allow the incident radiation to pass but which are constructed of a refractive material that imposes a phase shift of ±π. In addition it is known to provide Fresnel phase lenses with refractive materials profiled to give, at each radius of each zone in the lens, a phase shift such that the radiation arrives at the focal point P with exactly the correct phase, not just the nearest multiple of π. These Fresnel Phase Lenses are different from the original concept of Fresnel Lenses invented by Fresnel for use in lighthouses where the annular zones are replaced by concentric circular prisms whose flat edges resemble the curvature of spherical glass lenses and are further modified to produce the required focus at some point P, by refraction.

Accordingly, imaging can be achieved using the refraction or diffraction of Fresnel devices or by holographic means, or by some combination of them, throughout the electromagnetic spectrum and can also be applied to acoustic radiation and to neutrons such as thermal neutrons. Indeed it should be applicable to any radiation with a perceptible wavelength. For these reasons Fresnel zone plates can be used in applications such as microscopy, beam monitoring, condensers to increase the flux in waveguide experiments in the hard X-ray range, near-field imaging, bio-medical diagnosis, package inspection, thermal neutron imaging and focussing of acoustic radiation.

Acoustic Fresnel lenses have emerged in recent years as an alternative to the conventional spherical lenses for focusing sound waves in applications such as acoustic microscopy. Acoustic Fresnel zone plates have been used to focus ultrasonic waves, which are generated on the surface of a sample so that they are to be propagated within the sample so as to converge into a position at a certain depth, to induce a high-intensity ultrasonic source at that position. Acoustic Fresnel zone plates and Fresnel zone phase lens arrays have been used for acoustic ink printing and for other applications requiring economical acoustic focusing lenses.

Fresnel zone plates do suffer from a number of problems. Firstly they require many zones in order to achieve higher spatial resolution. They require several hundreds or thousands of zones to achieve a spatial resolution of higher than 25 nm. Due to the need for many zones, they are difficult to manufacture and indeed impossible to manufacture above a certain resolution due to the constraints on manufacture to a finite number of zones.

Secondly in order to be suitably focussed, the zone plates also require the incident radiation to be planar, monochromatic and coherent (and they do not focus incident radiation exactly at a point even if that radiation is planar, monochromatic and coherent). Furthermore, if the radiation is not monochromatic then each of the wavelengths contained within it will be focussed at a different point. Additionally the zone plate creates a high rate of chromatic aberration that can only be corrected over a limited bandwidth.

The image of a point source obtained by focussing for example is given by the auto-correlation function of the Fresnel zone plate. This is also referred to as the point spread function or impulse response function of the imaging system. The auto-correlation function of a Fresnel zone plate has comparatively high side lobes giving rise to artefacts in the image or distortions in the region surrounding the focus of radiation. Accordingly the image produced is significantly worse than if the auto correlation functions were the ideal delta functions.

Fresnel zone plates can be used to monchromatize light, by, for example, locating a pinhole aperture at the focus point of the desired wavelength and thus blocking other wavelengths which will be focussed at a different point. However, other than the need for the radiation to be monochromatic, use in this manner still suffers from the above problems.

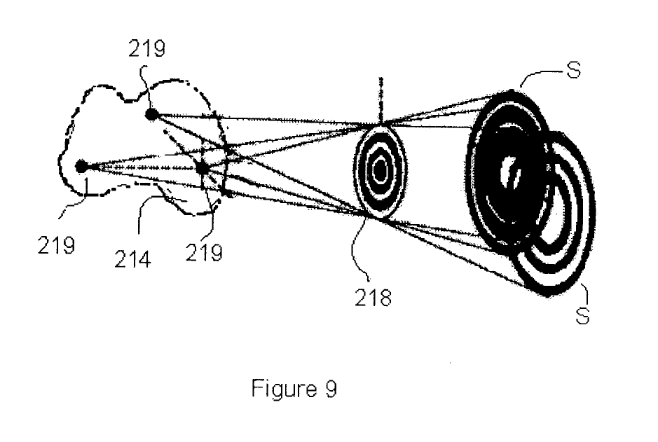

Additionally, Fresnel zone plates can be used with wavelengths and zones with relative dimensions such that diffraction effects are negligible. Points from the radiation source can cast shadows of the Fresnel zone plate onto a plane as shown in FIG. 9. In this manner they have been used in coded aperture imaging.

Imaging can be accomplished either by coded aperture imaging, or by diffraction or by refraction or by holographic means or by some combination of these and has applications throughout the electromagnetic spectrum, and can also be applied to acoustic radiation or thermal neutrons.

G. L. Rogers in a series of seminal papers formulated the connection between FZPs and holography which is a two-stage image formation process requiring coherent electromagnetic radiation. Rogers also reasoned that the hologram of a point source was a generalised (Fresnel) Zone Plate and proposed that holography could be accomplished with noncoherent light by the process of shadowgraph formation if the shadow was formed using a generalised (Fresnel) Zone Plate as the aperture casting the shadows thus giving rise to the concepts of noncoherent holography and of coded aperture imaging [Rogers, G. L., “Gabor diffraction microscopy: the hologram as a generalised zone plate”, Nature (GB) 116, 237, 1950; Rogers, G. L., “The black and white hologram”, Nature (GB), 116, 1027, 1950; Rogers, G. L., “Experiments in diffraction microscopy”, Proc. Roy. Soc. (Edinburgh) A63, 193-221, 1952; Rogers, G. L., “Artificial holograms and astigmatism”, Proc. Roy. Soc. (Edinburgh) A63, 313-325, 1952].

Using a Fresnel zone plate in coded aperture imaging suffers some of the same disadvantages as with use of the zone plate as a lens. Additionally, use of the zone plate in coded aperture imaging is only suitable in far-field applications, not in near-field.

It is also known to use linear chirp signals where the instantaneous temporal frequency increases linearly with time. This can be used in numerous applications, for example radar, sonar, magnetic resonance imaging (MRI), nuclear magnetic resonance (NMR) spectroscopy and seismic applications.

One problem with these chirp signals is that their autocorrelation function is a poor approximation to the ideal delta function response, viz. it has side lobes, artefacts that reduce the effectiveness of the chirp.

It is an object of the present invention to provide zone devices and chirp signals which mitigate some of the above identified problems.

In particular it has now been realised that a problem with both conventional zone plates and chirp signals is that they do not encode scalar wave equation-dependent amplitude and phase factors. For example, when a linear chirp signal is used to illuminate an object and its reflection or scatter is detected by an appropriate detector only the phase information that is encoded in the pulse is returned to the detector by the reflected or scattered pulse. The amplitude term in a linear chip is unity. Both phase and amplitudes should be required for example to accurately locate the object or image it. This phase and amplitude cannot be arbitrarily defined. It has been realised that the waveform or chirp signal to be used should be a solution to the scalar wave equation that governs wave propagation.

According to a first aspect in the invention there is provided a zoned radiation device for converging radiation of a wavelength λ to a focus at distance b, the device comprising a first set of zones and a second set of zones, wherein the first set of zones have a different characteristic to the second set and wherein the area of the zones decrease as their distance from the centre of the device increases, and one or more of radii at which a zone of the first set with a first characteristic switches to a second zone with a second characteristic are configured such that the device can focus the radiation with wavelength λ at a distance b with an autocorrelation/point spread function that is sharper than the autocorrelation/point spread function produced by radii configured to a Fresnel zone construction (of (nbλ)^{1/2} or (nbλ+(n²λ²)/4)^{1/2} from the centre of the zones where n=1, 2, 3 . . . increasing in consecutive integers for each radius from the centre).

According to a second aspect of the invention there is provided a non-linear chirp signal for carrying, collecting or determining data, the chirp having a frequency that increases or decreases with time, wherein the rate of increase or decrease of frequency of the chirp is configured such that the signal has an autocorrelation/impulse response function that is sharper than the autocorrelation/impulse response function produced by a linear chirp signal.

Preferably the zone distances are radii, more preferably radii from the predetermined point and/or the predetermined distance is the centre of the device and/or zones.

Preferably the first and/or second set of zones comprises one or more zones and preferably a plurality of zones and/or the areas of the zones decrease from the point as a function of n where n is an integer that increases by one for each zone. More preferably the areas of the zones vary approximately in proportion to {logₑ(n)−logₑ(n−1)}.

Preferably one or more zone distances/radii are substantially close to fitting the equation {bλ logₑ(n)}^{1/2} or {bλ logₑ(n)+(λ/2 logₑ(n))²}^{1/2} measured from the centre of the zones such that the device can focus the radiation with wavelength λ at b with an auto correlation function that is significantly sharper than the autocorrelation function produced by radii configured to the Fresnel construction of (nbλ)^{1/2} (nbλ+(n²λ²)/4)^{1/2}.

Preferably the zones are configured to produce a built in obliquity compensation factor which is preferably approximately proportional to {logₑ (n)−logₑ(n−1)}.

Preferably the first characteristic comprises a degree of transparency that is high relative to the second set of zones and the second characteristic comprises a degree of transparency that is low relative to the first set of zones, preferably wherein the second set of zones are opaque to the radiation of wavelength λ and/or the second set of zones comprises a refractive material which imposes a phase shift on radiation which passes through it and preferably is significantly transparent to the radiation.

Preferably the phase shift imposed on radiation of wavelength λ is ±π{logₑ(n)−logₑ(n−1)} preferably with the sign positive throughout, negative throughout or with alternating between + and − with n and/or at least some of the second set of zones comprises refractive material configured so that radiation of wavelength λ is operably converged by it to arrive at the focus with the correct phase. Preferably still the device comprises a material having a refractive index η and a thickness of about τ where τ=(λ/2η){logₑ(n)−logₑ(n−1)}.

The device according may be for converging, thermal neutrons, acoustic radiation, seismic waves, or electromagnetic radiation such as gamma or x-rays, as a teleconverter lenses, monochromatizer, collimator or ophthalmic lens

Preferably the zones are configured so that the image aberration is less than the image aberration produced by zones configured to the Fresnel construction and/or the configuration of zones is derivable from a solution to a wave equation that includes phase and a non-constant amplitude.

A two-dimensional array of apertures or lenses may be provided, preferably for use in acoustic ink printing, comprising one or a plurality of devices according to the first aspect of the invention.

A coded aperture may be provided comprising the device according to the first aspect of the invention for casting shadows in a plane from, and preferably not significantly diffracting, radiation of a wavelength smaller than λ.

Preferably one or more of external radiation source, a detector which can be sensitive to colour and/or polarization, a data processor and an image display for displaying a reconstructed image.

Preferably the image may encode information based on amplitude.

Preferably the processor is programmed to reconstruct an image of the object by using a decoding function which is preferably designed to reduce the side-lobes of the autocorrelation/point-spread-function of the coded aperture. More preferably the decoding function is scaled so that it operably obtains a reconstructed image of a two-dimensional slice of a three-dimensional object.

Preferably the detector is a flat panel detector configured to convert radiation, directly to a coded image and/or the detector is a flat panel detector configured to convert radiation, indirectly preferably by a fluorescent material in conjunction with a photo diode, to form the coded image and/or is configured to sequentially capture views of an object and/or that comprises a plurality of coded apertures to capture different views of the object and/or the processor is programmed to replace the coded image by a replacement image preferably by multiplying the values of the coded image by −1 in a digital version of the coded image or by making a contact print of the coded image, such as in use with photographic methods for recording the coded image.

The coded aperture system can be provided with an object wherein the detector is positioned relative to the object to receive radiation from the object within a cone of illumination, the base of the cone given approximately by

$${d}_{max} \leq 0.5 * {S}_{ci} ( \frac{{a}_{ca}}{{b}_{ca}} )$$

and the height of this cone given by a₂, where a₁+a₂=a_{ca} the total distance from the object to the coded aperture, dₘₐₓ is the maximum diameter of the object, s_{ci} diameter of the coded image at the detector.

The zoned device or imaging system according to the first aspect of the invention may be used in astronomy, nuclear medicine, molecular imaging, contraband detection, land mine detection, small animal imaging, detecting improvised explosive devices and imaging of inertial confinement fusion targets and/or with an object that is anatomical and/or radioactive, and/or in wireless applications, acoustic microscopy, and/or in concert halls for analysing and applying the acoustic response of a concert hall to music recorded in a studio or determining the presence of tumours comprising the step of evaluating a reconstructed image produced and/or in determining the existence of contraband articles comprising the step of evaluating a reconstructed image produced

The device may be off axis wherein the zones are off axis, the centre of the device being separate form the predetermined point.

The zones may be annular, circular, the zone distances comprise arcs of a circle and/or the zone distances from a line through the predetermined point are substantially constant along each zone.

Preferably the configuration of the rate of increase of frequency is derivable from a solution to a wave equation that includes phase and a non-constant amplitude.

Preferably the image may carry or collect or determine information based on/including encoded amplitude terms.

The signal is preferably of a form substantially close to

$$x ( t ) = cos \{ 2 π ( \frac{{a}_{ch}}{{b}_{ch}} exp ( {b}_{ch} t ) ) t + ϕ ( 0 ) \vert$$

where a_{ch} is an amplitude term and b_{ch} is the chirp rate and φ(o) is the phase at time zero, to produce a sharp autocorrelation function with small side lobes.

Preferably the pulses have a different initial phase φ(o) from each other. More preferably a second cycle of chirp pulses have a different initial phase φ(o) from the pulses of the first cycle.

A signal may be provided comprising a supercycle of a cycle of pulses according to the second aspect of the invention, such as to invert the longitudinal magnetisation in the sample in NMR applications, and/or for detecting the signals emitted by the sample in response to inversion of the longitudinal magnetisation.

According to a third aspect of the invention there is provided a method of coded aperture imaging of an object using the coded aperture or apparatus according to the first aspect of the invention.

According to a third aspect of the invention there is provided a method of producing a chirp signal or cycle comprising producing a signal or cycle according to any of claims 40 to 46 and/or the steps of constructing circles with radii approximately equal to {bλ logₑ(n)}^{1/2} or {bλ logₑ(n)+(λ/2 logₑ(n))²}^{1/2}; evaluating the distance between adjacent radii ΔRₙ=(Rₙ−Rₙ₋₁) where n=2,3,4,5; plotting the reciprocal of ΔRₙ against radius Rₙ; fitting a curve to this spatial frequency vs radius variation as this functional forms f(r) defines the instantaneous spatial frequency variation as a function of distance; determining the amplitude term a and the chirp rate b from curve fitting; using the relationship between the phase of the quantum chirp signal φ(r) and the instantaneous spatial frequency variation given by

$$f ( r ) = \frac{1}{2 π} \frac{d ϕ ( r )}{d r}$$

to construct a spatial signal approximately of the form x(r)=cos(φ(r)) and finally constructing a temporal chirp signal by replacing the distance variable with time and the spatial frequency with temporal frequency; preferably producing a temporal chirp of the form

$$x ( t ) = cos \{ 2 π ( \frac{{a}_{ch}}{{b}_{ch}} exp ( {b}_{ch} t ) ) t + ϕ ( 0 ) \vert$$

where a_{ch} is an amplitude term and b_{ch} is the chirp rate and φ(o) is the phase at time zero.

Embodiments of the invention are now described, by way of example only, with reference to the accompanying drawings, in which:

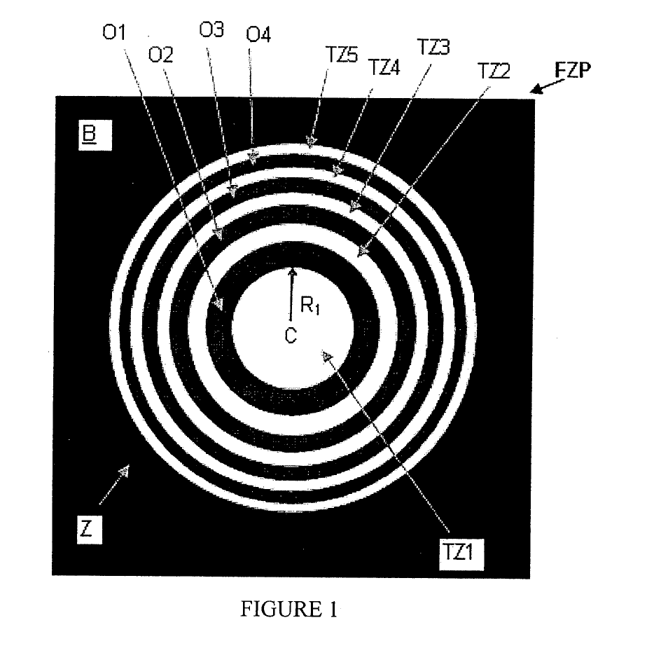

FIG. 1 is a view of a Fresnel zone plate known in the prior art;

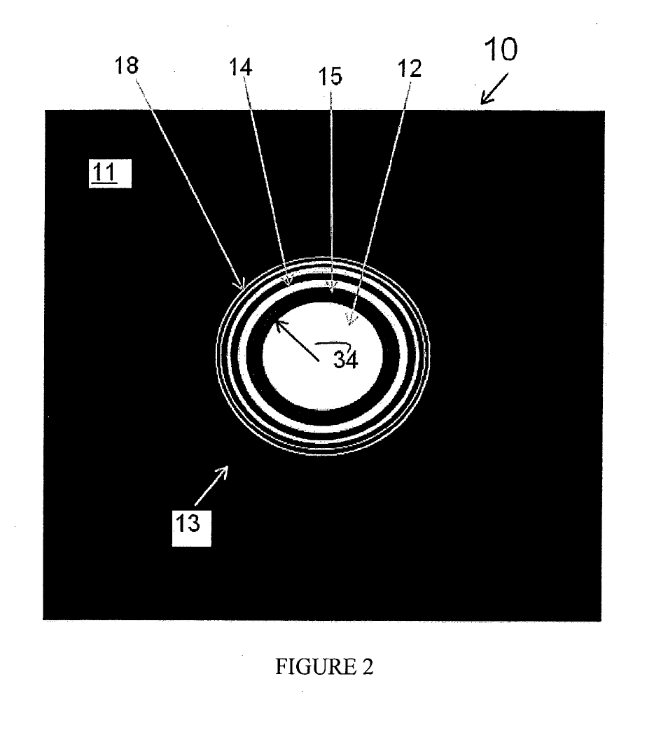

FIG. 2 is a view of a zone plate constructed in accordance with the invention and hereinafter sometimes referred to as a “quantum zone plate”;

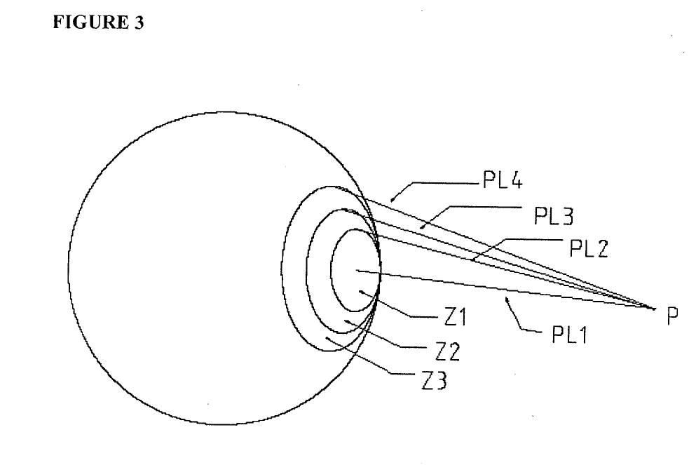

FIG. 3 is a three-dimensional depiction of the path lengths from the focus P to zones following the Fresnel zone construction;

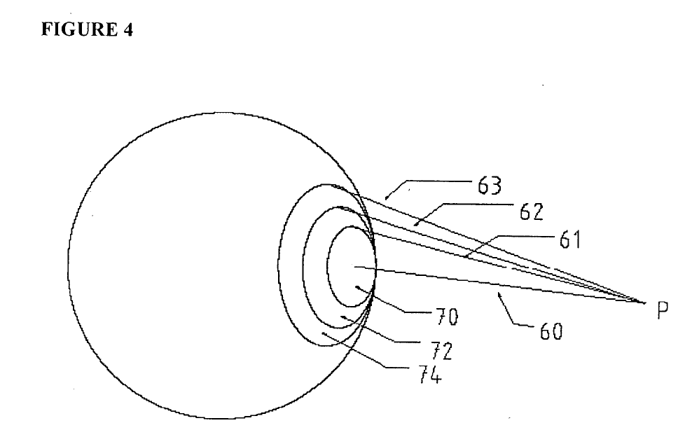

FIG. 4 is a three-dimensional depiction of the path lengths between focus P and zones constructed in accordance with the invention, hereinafter sometimes referred to as “quantum zone construction”;

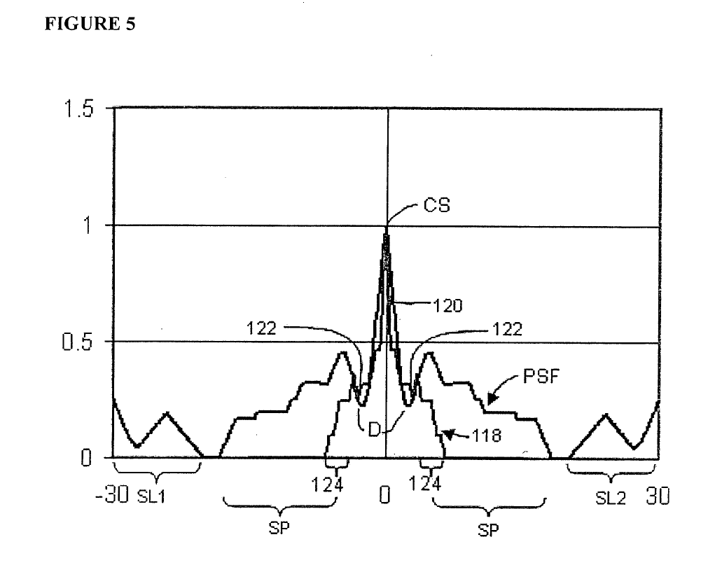

FIG. 5 shows the point spread function of a Fresnel zone plate known from the prior art and the point spread function of a zone plate in accordance with the invention;

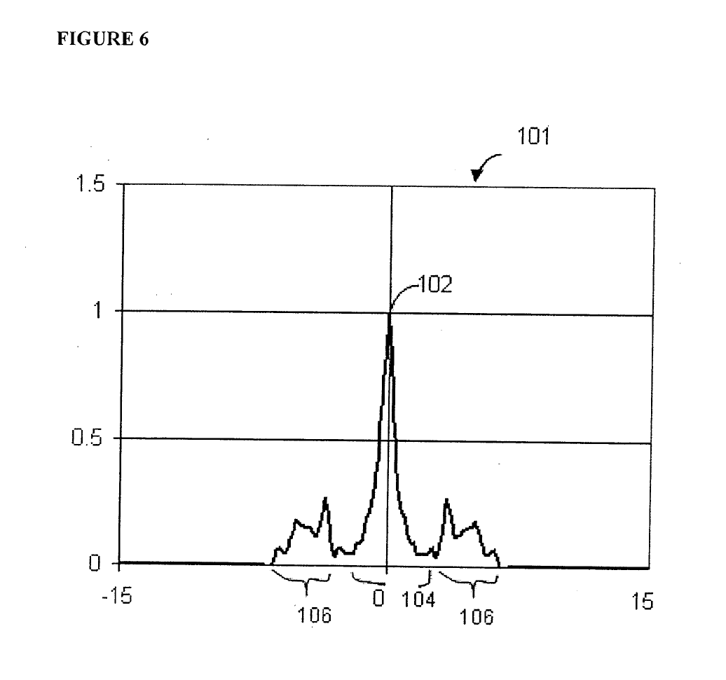

FIG. 6 is the point spread function of a coded aperture used for imaging in accordance with the invention;

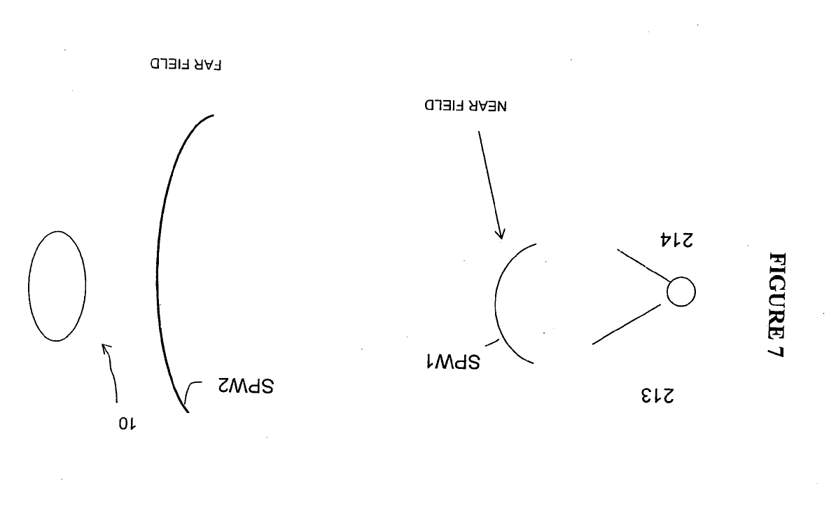

FIG. 7 depicts spherical wave fronts in near-field and far-field applications;

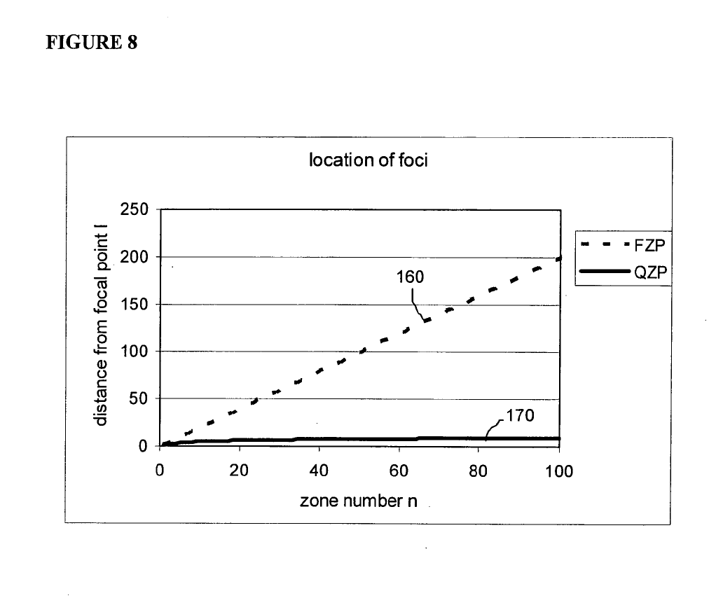

FIG. 8 is a graph of the spacing of the foci with number of zones (n) for both prior art (Fresnel type) and zone plates according to the invention;

FIG. 9 is a schematic view of the shadows produced by a coded aperture in accordance with the invention;

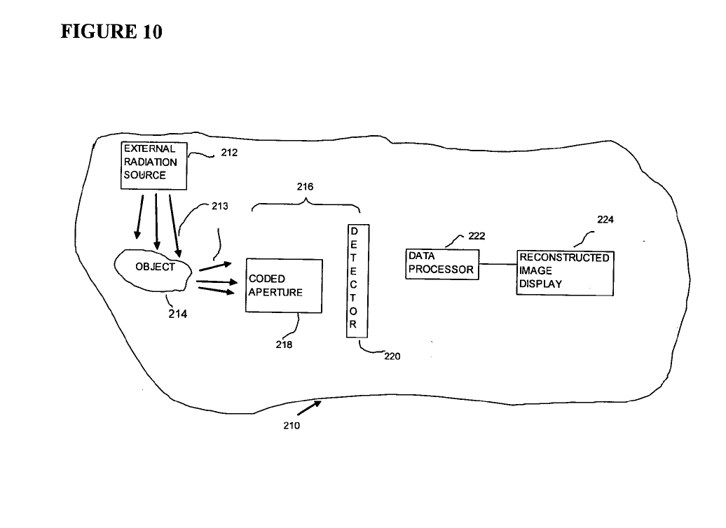

FIG. 10 is a schematic view of coded aperture imaging apparatus in accordance with the invention, incorporating the aperture of FIG. 9;

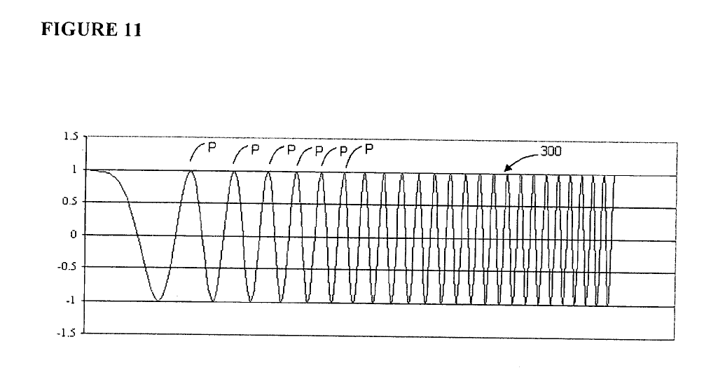

FIG. 11 shows a linear chirp known from the prior art;

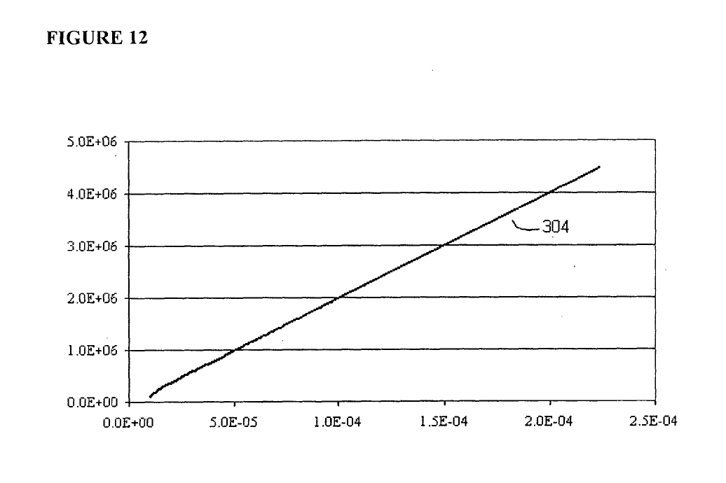

FIG. 12 depicts the relationship between the radius of a Fresnel zone construction and spatial frequency in graphical form;

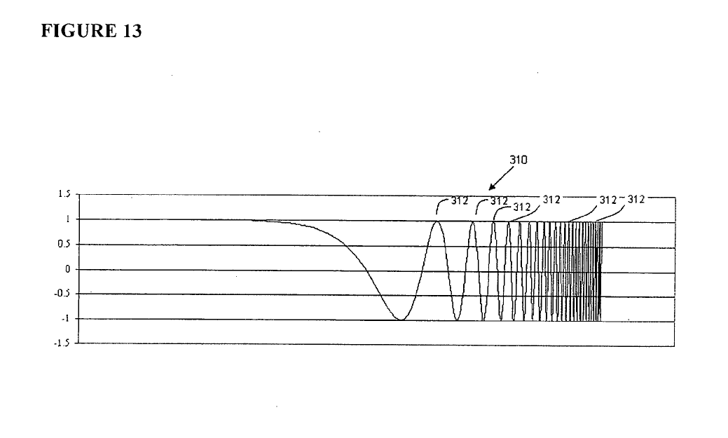

FIG. 13 is an illustration of a chirp in accordance with the invention using quantum zone construction;

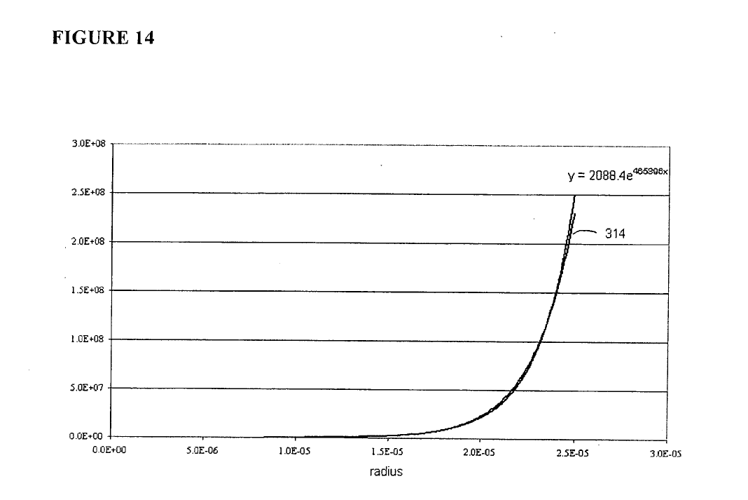

FIG. 14 is a graph of the variation of the radius of zone construction named quantum zone construction in accordance with the invention, depicted against spatial frequency; and

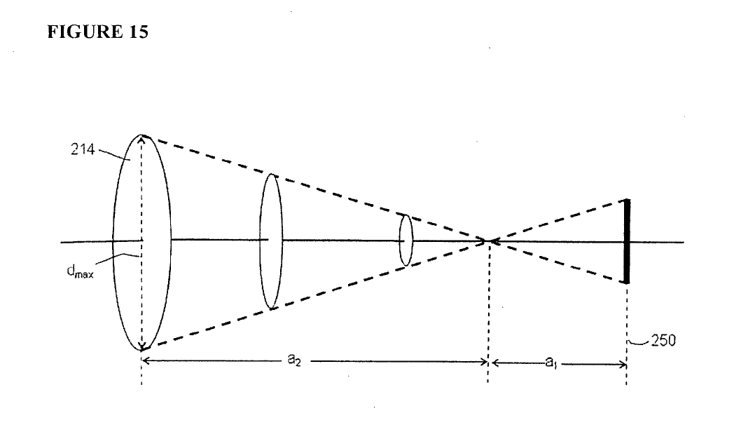

FIG. 15 depicts a “cone of illumination” in which an object can be placed for coded aperture imaging in accordance with the invention such as with use of the apparatus of FIG. 10

Referring to FIG. 1 there is shown a Fresnel zone plate FZP. The FZP is supported by a background plate B that is opaque to the radiation to be focussed. In this case we will use the example of the radiation to be focussed for both this and the invention to be visible light. Accordingly background B is opaque to visible light.

Emanating from the centre C of the zone plate FZP are a number of zones Z. The first zone TZ1 is in the form of a circle and the remainder O1-TZ5 etc are in the form of a ring or annulus, with there being no gaps between the zones Z. Whilst the amount by which each radius increases for the next successive zone decreases away from the centre, the area of each zone Z, which is dependent on the increasing radius, is approximately equal. Accordingly it can be seen as a series of bands that get successively narrower from the centre, which are of essentially equivalent area.

The zones O1, O2, O3 etc are opaque in the same manner as the background B. The zones TZ1, TZ2, TZ3 etc are transparent to light (or whichever radiation is wished to be focussed) and may have been formed by lithography or etching for example. The zones alternate between opaque and transparent with a transparent zone TZ1, followed by an opaque zone O1, followed by a transparent zone TZ2, followed by an opaque zone O2 etc. It is this alternation and having areas of approximately the same size which are the key to the Fresnel zone construction.

Each of the zones can be said to have a radius Rₙ, which defines where the zone ends and the next zone starts. In FIG. 1 radius R₁ depicts the radius of the first zone TZ1 which is a circle.

The Fresnel zone plate FZP is correctly configured so that a wavelength of light is focussed towards point P. The radius R is approximately equal to the square root of the wavelength (λ) of the radiation multiplied by the distance b which is the perpendicular distance to the desired focus point P. The radius of O1 is approximately equal to the square root of λb and the overall formula for the radius is Rₙ≈\sqrt{nλb} where n in an integer which increases (1, 2, 3 etc) by one for each subsequent zone. Accordingly the radius of TZ5, which is the 9^{th} zone, would be R₉≈3\sqrt{λb}. The Fresnel zone plate FZP is configured such that b can be the same number for each radius when it is constructed so that there is one (approximate) focus per wavelength at point P.

If the radiation sent to the plate FZP has a different wavelength λ then it will have a different focus point, but will still have the same single focal point for each zone Z provided it is monochromatic and illuminated evenly across the zone plate FZP.

FIG. 2 shows a zone plate 10 in accordance with the invention which can be referred to as a quantum zone plate. The quantum zone plate 10 comprises zones 13 on a background 11. The background is substantially similar to background B in FIG. 1. Zones 13 include a first circular transparent zone 12 then an opaque annular zone 15 then a transparent annular zone 14 with alternating transparent and opaque annular zones in a similar manner to Fresnel zone plate FZP. However, it can be seen that the amount by which the radius of each successive zone increases, decreases much more rapidly than with the zone plate FZP. The radius Rᵢᵢ for successive zones decreases more rapidly with n with zone plate 10 than in zone plate FZP.

Significantly it can be seen that the area of each zone is not constant but varies with n, decreasing significantly as the radii increase. The total area contained in the zones 13 is considerably smaller than the prior art zone plate FZP for the same focal length and equivalent number of zones.

With zones 13 radius 34 of circular zone 12 is equal to {bλ logₑ(2)}^{1/2}. The general form for the radius is Rₙ={bλ logₑ(n)}^{1/2} where n starts at two and increases in integers increasing by one with each zone. Accordingly the radius of zone 18 for example is equal to {bλ logₑ(9)}^{1/2}.

As will be seen below, in actual fact the two radii Rₙ given above are approximations of the formula for constructing zone plates according to the prior art FZP or for producing the quantum zones 13. The correct formula in each case will be Rₙ=(nλb+n²λ²/4)^{1/2} for the plate FZP and Rₙ=[bλ logₑ(n)+{(λ²/4)(logₑ(n))²}]^{1/2} for zones 13. However the approximate forms are often acceptable since b is generally much larger than the radius of the zone plate and/or the wavelength is fairly small such that the term proportional to λ² and without b will generally be fairly negligible compared to the bλ term. Ignoring the term containing λ² does in fact introduce a level of “image aberration” discussed below.

In FIG. 3 is a three dimensional depiction of the Fresnel zone construction with the path lengths from a focus P. The zones of plate FZP are equivalent to a flat projection of the zones shown.

As shown, the path length PL1 is from point P to the centre of the zone Z1. Each of the path lengths PL2, PL3, PL4 are from point P to the start of each subsequent zone Z2, Z3 and the not-shown fourth zone Z4 (corresponding to the end of radius Z3).

As shown the path PL1 is b, at PL2 it is b+λ/2, at PL3 it is b+λ, at PL4 is b+3λ/2. Accordingly it can be seen that the path length increases by λ/2 for succeeding zones.

The Fresnel construction can be seen to be derived from a wave function to measure distance.

Defining distance l(λ) by l(λ)= [symbol] and using the solution to the wave equation given by ψ=e^{{ik(r-ct)} gives the Fresnel construction l(λ)=nλ/}2+b, starting at n=1. This gives the distance from point P to the outer boundary of each zone. This can be seen to be the same as the path lengths shown in FIG. 3.

It can be seen from this solution to the wave equation that the Fresnel construction and Fresnel zone plates incorporates only phase and not amplitude. The radiation passing through adjacent zones differ in phase by +π. The amplitude is also dependent on the area of the zones which are approximately constant in the case of Fresnel zones. It can be deduced from the equation for the radii of Fresnel zones that the area Aₙ=πbλ+λ²π(2n−1)/4 and for the reason stated above the λ² term which is not multiplied by b is negligible and the remaining area is πbλ which is independent of n.

As stated earlier, the radius of the Fresnel zone R_{n(FZP)} is given by the expression:

Rₙ(FZP)=\sqrt{bnλ+(nλ/2)²}, (i)

where b is the axial distance from the aperture/lens plane to the focal point P and λ is the wavelength of the incident radiation and n is the zone number.

Using the so-called thin lens equation also referred to as the lensmaker's formula which can be re-written as the Gaussian lens formula given by

$$\frac{1}{λ} + \frac{1}{{λ}^{′}} = \frac{1}{f}$$

where λ and λ′ are the object to lens distance and lens to image distance respectively, the focal length of a Fresnel zone plate/lens f_{FZP} can be written as:

$${f}_{n ( F Z P )} = \frac{( {R}_{n}^{2} - {R}_{n - 1}^{2} )}{λ} , \qquad ( ii )$$

where n=1, 2, 3, 4 . . . and where R₀=0.
There are several foci associated with a Fresnel zone plate/lens type aperture, each focus emanating from the zone element (Rₙ²−Rₙ₋₁²). In a binary (transparent and opaque) Fresnel zone plate, for example, the foci will be formed from the transparent (Fresnel) zones TZ1 etc, thus foci such as f₁, f₃, f₅, f₇ . . . will be formed. The primary focus f₁ of a Fresnel zone plate/lens is given when n=1 as:

$${f}_{1} = \frac{{R}_{1 ( FZP )}^{2}}{λ} . \qquad ( iii )$$

Note that (Rₙ²−Rₙ₋₁²) can be approximated by (2R_{n(FZP)}ΔR_{n(FZP)}) by ignoring terms in (ΔRₙ)² so the foci f_{n(FZP)} can be approximated by the expression:

$${f}_{n ( FZP )} \approx \frac{( 2 {R}_{n ( FZP )} Δ {R}_{n ( FZP )} )}{λ} . \qquad ( iv )$$

When R_{n(FZP)} is the radius of the largest Fresnel zone, N and ΔR_{n(FZP)} is the width of the finest Fresnel zone, equation (iv) can be written in terms of the diameter of the Fresnel zone plate/lens D_{FZP} to give:

$${f}_{N ( FZP )} \approx \frac{( {D}_{FZP} Δ {R}_{N ( FZP )} )}{λ} . \qquad ( v )$$

The foci of a Fresnel zone plate/lens can also be written in terms of f, λ and n to give an expression of the form:

$${f}_{n ( FZP )} = b + \frac{λ}{4} ( 2 n - 1 ) , \qquad ( vi )$$

where n=1, 2, 3, 4, . . .

If we ignore terms containing λ² then from equation (i) we get R_{n(FZP)}²≈bnλ and from equation (vi) we get f_{n(FZP)}≈b.

Equation (vi) shows that in addition to the primary focus at b there are many foci one for each zone n. The second term in equation (vi) provides a measure of the image aberration due to multiple images, one from each contributing zone. This image aberration is reduced with the quantum zone construction used in the present invention. In this instance viz., ignoring terms containing λ² we can write the radius of the Fresnel zone R_{n(FZP)} as:

R_{n(FZP)}≈(bnλ)^{1/2} (vii)

or

R_{n(FZP)}≈(fₙnλ)^{1/2}. (viii)

Some well known expressions follow as a result and when n=N the outermost zone we get an expression for the diameter of the Fresnel zone plate/lens D_{FZP} using equations (v) and (viii) as:

D_{FZP}≈4NΔR_{n(FZP)}. (ix)

Substituting equation (ix) into equation (v) we get an expression for the focus f_{N(FZP)}.

$${f}_{N ( FZP )} \approx \frac{( 4 N Δ {R}_{N ( FZP )}^{2} )}{λ} . \qquad ( x )$$

The Numerical Aperture (NA) of the Fresnel zone plate/lens is given by

$$NA = \frac{{D}_{FZP}}{2 {f}_{N ( FZP )}}$$

and can be written as using equation (v) to give:

$$NA \approx \frac{λ}{2 Δ {R}_{N ( FZP )}} . \qquad ( xi )$$

The f-number of the Fresnel zone plate/lens denoted by F^{#} is given by the expression

$${F}^{\#} ≡ \frac{{f}_{N ( FZP )}}{{D}_{FZP}}$$

and is expressed by:

$${F}^{\#} \approx \frac{Δ {R}_{N ( FZP )}}{λ} . \qquad ( xii )$$

The spatial resolution Δλof a Fresnel zone plate/lens is given by the following expressions:

Δλ26 1.22ΔR_{n(FZP)}, (xiii)

for coherent radiation often simplified to

Δλ≈ΔR_{n(FZP)} (xiv)

and by:

ΔN≈2ΔR_{n(FZP)} (xv)

for coded aperture imaging.

The Depth of Focus (DOF), Δz is given by the expression number

$$Δ z \approx \pm \frac{1}{2} \frac{λ}{{( NA )}^{2}}$$

or equivalently by

$$Δ z \approx \pm 2 {λ ( {F}^{\#} )}^{2} and Δ z \approx \pm \frac{2 {( Δ {R}_{n} )}^{2}}{λ} . \qquad ( xvi )$$

At the focal plane corresponding to the primary focus f₁ the depth z is given by z=f₁ and the locations of secondary images along the depth axis z are given by z=f₁±mΔz. For example the spatial location at two depth of focus away from the primary focus is given when m=2 and similarly for the case of four depth of focus away from the primary focus is given when m=4 and so on.

The tables below contain an example of the above parameters for Fresnel zone plate/lens as used in soft x-ray image formation.

| λ (nm) | Δr (nm) | N | D (μm) | f (mm) | NA | F^{#} |
|---|---|---|---|---|---|---|
| 2.5 | 25 | 618 | 62 | 0.62 | 0.05 | 10 |

| resolution (l) | l (nm) | DOF | Δz (μm) |
|---|---|---|---|
| ≈Δr | 25 | one DOF | 0.5 |
| ≈1.22Δr | 31 | two DOF | 1 |
| ≈2Δr | 50 | four DOF | 2 |

Referring to FIG. 4 there is shown a corresponding three-dimensional depiction of the zone construction in accordance with the invention, which we name the “quantum zone construction”.

Rather than using

$$ψ = {e}^{\{ i k ( r - ct ) \}} , ψ = \frac{π}{kr} {e}^{\{ i k ( r - ct ) \}}$$

is used instead and therefore amplitudes are also incorporated. This gives l(λ)=λ/2 logₑ(n)+b starting at n=2. This gives the distance from point P to the outer boundary of each zone. The outer boundary of the central circular zone is given when n=2. This is the quantum zone construction.

On FIG. 4 path length 60 is equal to b, path length 61 (corresponding to the beginning of the second zone 72) is b+logₑ(2) λ/2 etc. Accordingly it can be deduced that the phase varies according to π{logₑ(n)−logₑ(n−1)} and the amplitude is incorporated into the zone construction by the choice for ψ.

Therefore the distance between boundaries of successive zones and the point P varies as

b,b+logₑ(2)λ/2, b+logₑ(3)λ/2, . . . b+logₑ(n)λ/2 for n=2,3 . . .

so that the boundaries between successive zones are {logₑ(n)−logₑ(n−1)} λ/2, farther from point P and the phase of the secondary sources vary from point P according to it π{logₑ(n)−logₑ(n−1)}. The amplitude of the secondary sources from the zones is also proportional to area Aₙ of the n^{th} quantum zone which is given by the expression containing a term, {logₑ(n)−logₑ(n−1)}. In the quantum zone construction both amplitude and phase of the secondary sources vary as a function of the zone number, n. The area (thus amplitude and phase) decreases very rapidly at first then decreases slowly as n increases providing a built-in obliquity compensation factor.

Accordingly unlike the Fresnel zone plate construction, the quantum zone construction incorporates both amplitude and phase. Phase, amplitude and area of the zones vary as a function of n.

The radius R_{n(QZP)} of a quantum zone is given by the expression:

R_{n(QZP)√}\sqrt{bλ log₂(n)+{λ/2 logₑ(n)}²}, (xvii)

where b is the axial distance from the aperture/lens plane to the focal point P and λ is the wavelength of the incident radiation and n is the zone number.

Using the so-called thin lens equation also referred to as the lensmaker's formula can be re-written as the Gaussian lens formula given by

$$\frac{1}{λ} + \frac{1}{{λ}^{′}} = \frac{1}{f}$$

where λ and λ′ are the object to lens distance and lens to image distance respectively, the focal length of a quantum zone plate/lens can be written as:

$${f}_{n ( QZP )} = \frac{( {R}_{n}^{2} - {R}_{n - 1}^{2} )}{\{ {log}_{e} ( n ) - {log}_{e} ( n - 1 ) \} λ} \qquad ( xviii )$$

where n=2, 3, 4, . . . and Rₙ are the radii of the quantum zone and R₁=0.

Observe that, as in the case with a FZP, there are several foci associated with a quantum zone plate/lens type aperture, each focus emanating from the zone element (Rₙ²−Rₙ₋₁²)/{logₑ(n)−logₑ(n−1)}. In a binary QZP for example the foci will be formed from the transparent (quantum) zones, thus foci such as f₂, f₄, f₆, f₈ . . . will be formed.

The primary focus f₂ of a quantum zone plate/lens is given when n=2 as:

$${f}_{2} = \frac{{R}_{2}^{2}}{λ {log}_{e} ( 2 )} . \qquad ( xix )$$

Note that (Rₙ²−Rₙ₋₁²) can be approximated by (2R_{n(QZP)} ΔR R_{n(QZP)}) by ignoring terms in (ΔRₙ)² so the foci f_{n(QZP)} can be approximated by the expression:

$${f}_{n ( Q Z P )} \approx \frac{( 2 {R}_{n ( Q Z P )} Δ {R}_{n ( Q Z P )} )}{\{ {log}_{e} ( n ) - {log}_{e} ( n - 1 ) \} λ} . \qquad ( xx )$$

When R_{n(QZP)} is the radius of the largest quantum zone, N and ΔR_{n(QZP)} is the width of the finest quantum zone, equation (xx) can be written in terms of the diameter of the quantum zone plate/lens D_{QZP} to give:

$${f}_{N ( Q Z P )} \approx \frac{( {D}_{Q Z P} Δ {R}_{N ( Q Z P )} )}{\{ {log}_{e} ( N ) - {log}_{e} ( N - 1 ) \} λ} . \qquad ( xxi )$$

The foci of a quantum zone plate/lens can also be written in terms of f, λ and n to give an expression of the form:

$${f}_{n ( Q Z P )} = b + \frac{λ}{4} \{ {log}_{e } ( n ) + {log}_{e} ( n - 1 ) \} \qquad ( xxii )$$

where n=2, 3, 4, . . .

If we ignore terms containing λ² then from equation (xvii) we get Rₙ²≈bλ logₑ(n) and from equation (xxii) we get f_{n(QZP)}≈b.

Terms in equations (i) and (xvii) containing λ² are extremely small compared to those containing λ, so ignoring them will lead to only minute errors in construction of the zone plates; the series of images will be almost coincident, unlike those from the Fresnel zone plate. This image aberration can be quantified using the terms

$$\frac{λ}{4} \{ {log}_{e} ( n ) + {log}_{e} ( n - 1 ) \} and \frac{λ}{4} ( 2 n - 1 ) .$$

In this instance, viz. ignoring terms containing λ², we can write the radius of the quantum zone R_{n(QZP)} as:

R_{n(QZP)}≈{bλ logₑ(n)}^{1/2} (xxiii)

Or

R_{n(QZP)}≈{f_{n(QZP)}λ logₑ(n)}^{1/2}. (xxiv)

We now derive analogous expressions to those for the FZP. When n=N, the outermost quantum zone, we can obtain an expression for the diameter of the quantum zone plate/lens as:

$${D}_{Q Z P} \approx \frac{4 {log}_{e} ( N ) Δ {R}_{N ( Q Z P )}}{\{ {log}_{e} ( N ) - {log}_{e} ( N - 1 ) \}} . \qquad ( xxv )$$

Substituting equation (xxv) into equation (xxi) we get an expression for the focus f_{N(QZP)} as:

$${f}_{N ( Q Z P )} \approx \frac{4 {log}_{e} ( N ) {ΔR}_{N ( Q Z P )}^{2}}{λ {\{ {log}_{e} ( N ) - {log}_{e} ( N - 1 ) \}}^{2}} . \qquad ( xxvi )$$

The Numerical Aperture (NA) of the quantum zone plate/lens is given by

$$N A = \frac{{D}_{Q Z P}}{2 {f}_{N ( Q Z P )}}$$

and can be written as using equation (xxi) to give:

$$N A \approx \frac{λ \{ {log}_{e} ( N ) - {log}_{e} ( N - 1 ) \}}{2 Δ {R}_{N ( Q Z P )}} . \qquad ( xxvii )$$

The f-number of the quantum zone plate/lens denoted by F^{#} is given by the expression

$${F}^{\#} ≡ \frac{{f}_{N ( Q Z P )}}{{D}_{Q Z P}}$$

and is expressed by:

$${F}^{\#} \approx \frac{Δ {R}_{N ( Q Z P )}}{λ \{ {log}_{e} ( N ) - {log}_{e} ( N - 1 ) \}} . \qquad ( xxviii )$$

The spatial resolution Δλ of a quantum zone plate/lens is given by the following expressions:

Δλ≈1.22ΔR_{N(FZP)}, (xxix)

for coherent radiation often simplified to:

Δλ≈2ΔR_{N(QZP)} (xxx)

and by:

Δλ≈ΔR_{N(QZP)}. (xxxi)

for coded aperture imaging.

The Depth of Focus (DOF), Δz is given by the expression

$$Δ z \approx \pm \frac{1}{2} \frac{λ}{{( N A )}^{2}}$$

or equivalently by

$$Δ z \approx \pm 2 {λ ( {F}^{\#} )}^{2} and Δ z \approx \pm \frac{2 Δ {R}_{N ( Q Z P )}^{2}}{λ {\{ {log}_{e} ( N ) - {log}_{e} ( N - 1 ) \}}^{2}}$$

Below is a table of a zone plate in accordance with the invention used in soft x-ray image formation.

Quantum Zone Plate/Lens in Soft X-Ray Image Formation 1

| λ (nm) | Δr (nm) | N | D (μm) | f (μm) | NA | F^{#} |
|---|---|---|---|---|---|---|
| 2.5 | 0.40 | 618 | 6.3 | 618 | 0.005 | 98 |

| resolution (l) | l (nm) | DOF | Δz (μm) |
|---|---|---|---|
| ≈Δr | 0.40 | one DOF | 48 |
| ≈1.22Δr | 0.48 | two DOF | 96 |
| ≈2Δr | 0.79 | four DOF | 192 |

As can be seen, for the same number of zones as the Fresnel example given earlier the resolution is far superior to conventional plate FZP.

A further example

| λ (nm) | Δr (nm) | N | D (μm) | f (μm) | NA | F^{#} |
|---|---|---|---|---|---|---|
| 2.5 | 24.23 | 16 | 4.2 | 618 | 0.003 | 150 |

| resolution (l) | l (nm) | DOF | Δz (μm) |
|---|---|---|---|
| ≈Δr | 24.23 | one DOF | 113 |
| ≈1.22Δr | 29.56 | two DOF | 226 |
| ≈2Δr | 48.46 | four DOF | 451 |

shows that comparable resolution to the FZP above can be achieved using a quantum zone plate with only 16 zones instead of 618.

Additionally, the auto-correlation function of the quantum zone plate 13 is much closer to a delta function than the auto-correlation function of a conventional Fresnel zone plate FZP is. It is sharper with smaller side lobes. In optics the auto-correlation function is often referred to as the point-spread function since it defines the propagation of the radiation from a point source.

The point-spread function of a quantum zone plate similar to plate 10 and a Fresnel zone plate similar to plate FZP, depicted in terms of amplitude which is the square root of the intensity of radiation received at the focus, are shown in FIGS. 5 and 6.

FIG. 5 shows the point-spread function PSF of a 9-zoned Fresnel zone plate and the point spread function 118 of a 9-zoned quantum zone plate. The horizontal axis depicts the distance from the centre of the image, and the vertical axis depicts amplitude.

The Fresnel point spread function PSF has a central spike CS at the centre of the image. Moving from the centre there are symmetric dips D, then two side portions SP, then side lobes SL1 and SL2. The side portions SP start at an amplitude of around 0.4 and decrease to close to 0 at a distance of around 20 units from the centre. The side lobes SL1 and SL2 increase from the end of the side portions SP up to an amplitude of around 0.25 at 30 units form the centre.

The point-spread function 118 of a 9-zone quantum zone plate comprises central spike 120, dips 122, and side portions 124. Spike 120 and dips 122 are similar to central spike CS and dips D, except that spike 120 is sharper/narrower than spike CS and the dips 122 don't return to as high an amplitude. The side portions 124 start at a lower amplitude then decrease much quicker than side portions SP reaching 0 amplitude at a distance of only around 6 units. There are no side lobes equivalent to side lobes SL1 and SL2. The point-spread function 118 of the quantum zone plate has a small side portion 124 of comparatively small amplitude but in comparison to the function PSF it is relatively similar to a delta function.

FIG. 7 is a depiction of curvature of the spherical wave in both near-field and far field states. This can be seen with the far-field spherical wave SPW2 which is much further from the initial object 214 has considerably less curvature than the spherical wave SPW1 which is nearer to the object 214. Accordingly, the spherical wave SPW2 is almost planar by the time it reaches the zone plate 10. Accordingly at this point conventional Fresnel zone plates FZP would be effective to a certain extent since these will work with planar waves.

However, Fresnel zone plates FZP are not appropriate in near-field applications because the spherical wave SPW1 is significantly curved and cannot be treated as a planar wave. Accordingly, Fresnel zone plates FZP are not appropriate. Additionally, most known coded apertures suffer from the same problem of requiring an evenly illuminated planar wave across the aperture. Apertures and devices that are constructed according to the invention such as by using quantum zone construction, are useable in near-field because the obliquity compensation factor allows for use with spherical waves like SPW1. A further detailed explanation of the benefits of using a coded aperture constructed with quantum zones in near field applications is given later.

In FIG. 8 is shown the distribution and location of foci. A line representing the Fresnel zone construction is marked 160 and a line representing quantum zone construction marked 170. This figure indicates that foci in the Fresnel type devices increase linearly as n increases whilst for quantum zone based devices and apertures these foci gradually increase but rapidly reach a plateau as n increases. In comparative terms, these foci will lie closer to the primary focus than they do in Fresnel zone type devices/apertures. The reason why the foci are not perfectly coincident (and the line 170 in FIG. 8 is not coincident with the horizontal axis) is largely due to the Gaussian lens formula approximation.

A significant difference between devices or apertures based on the quantum zone construction and Fresnel's zone construction is the wavelength dependent term that specifies the nature and location of the wavelength and zone number dependent terms for the foci. For the quantum zone construction based devices of the invention, this is given by the term

$$\frac{λ}{4} \{ {log}_{e} ( n ) + {log}_{e} ( n - 1 ) \} .$$

Devices based on Fresnel's zone construction it is given by the term

$$\frac{λ}{4} ( 2 n - 1 ) .$$

The distribution and extent of these multiple foci due to the annular zone constructions of either Fresnel or quantum provides a measure of the image aberration of such devices or apertures when used in imaging.

For soft X-rays of wavelength λ=0.1 nm and for a given number N, where N=101 of quantum or Fresnel zones,

$$\frac{λ}{4} \{ {log}_{e} ( n ) + {log}_{e} ( n - 1 ) \} = 0.23 nm and \frac{λ}{4} ( 2 n - 1 ) = 5 nm .$$

Devices or apertures based on the quantum zone construction have much lower image aberration than devices or apertures based on Fresnel's zone construction.

In total therefore, use of quantum zone construction to make plate 10 rather than conventional Fresnel zone constructions derives a built-in obliquity compensation factor which includes near-field imaging; produces less image aberration; has a sharper impulse response, auto correlation function or point-spread function; incorporates phase and amplitude; requires less zones for the same spatial resolution and is therefore easier to manufacture, and can be manufactured with a much greater resolution than has previously been possible.

It is also possible to make phase lenses and phase zone plates in accordance with the invention. These are constructed by similar methods to conventional Fresnel lenses and Fresnel phase zone plates but using the zone construction described above, that is the so-called quantum zone construction. Accordingly devices constructed in this manner may be named “quantum phase zone plates” where all zones are transmitting but with alternate zones having a negative phase shift and “quantum phase lenses” where all zones are transmitting with appropriate phase shifts described herein.

It is also possible to make linear one dimensional equivalents or off-axis equivalents of quantum zone plates, quantum phase zone plate and quantum phase lens to be used for imaging and applications in a similar manner to making such equivalent to Fresnel zone plates but using the equations above. An off axis equivalent may, for example, be created by placing a circular aperture in a an opaque background over an normal on-axis zone plate and moving the centre of the aperture away from the centre of the zones. A linear one dimensional equivalent could be a created by placing a rectangular aperture in a an opaque background over an normal on-axis zone plate or by making the zones straight rather than annular, with the distances between each zone and a line thorough the centre of the zones being equal to the radii calculated above.

In FIG. 9 is shown a schematic representation of a principle of making a coded image using coded apertures. The coded aperture 218 lies between the object 214 and the plane where the coded image is recorded. Each radiation-emitting point in the object 219 casts a shadow S of the coded aperture on to the detector. In this example it can be seen that there are three overlapping shadow images. In reality there will be many points 219 on the object and many overlapping shadow images.

Referring to FIG. 6, the point-spread function 101 of a 9-zone quantum zone coded aperture is shown. The horizontal axis depicts the distance from the centre of the image, and the vertical axis depicts amplitude. Function 101 comprises a central spike 102, dips 104, and side portions 106.

Function 101 is similar to function 118, except that the dips decreases to a lower amplitude. The side portions 106 then start from a lower amplitude. Again there are no side lobes equivalent to side lobes SL1 and SL2 and in comparison to the function PSF function 101 is relatively similar to a delta function.

Referring to FIG. 10 there is shown a system 210 for imaging an object 214 according to the present invention. The system 210 comprises an optional external radiation source 212, the object 214, an imaging camera 216, a data-processor 222 and a reconstructed image display 224. The imaging camera 216 has a predetermined field of view and comprises a coded aperture 218 constructed with zones using quantum zone construction and a detector 220. Instead of an external radiation source 212 the object 214 may be self-radiating.

In operation, an object 214 or a portion of an object to be imaged is positioned within the field of view of the imaging camera 216, where the camera is at a selected distance from the object 214. Alternatively, the object 214 can remain stationary, and the camera can be positioned such that the object 214 or portion of the object of interest is within the field of view of the camera.

In medical applications the object 214 can be matched to the field of view of the camera 216 by placing a mask/masking cape 215 over the object 214, such that all unmasked areas that emit radiation will form complete shadows. This will ensure that the coded image generated at the detector 220 is not corrupted by incomplete shadows from outside the field of the view of the camera and therefore be able to minimise reconstruction artefacts that are present in the decoded image.

The source 212 (or object 214) emits radiation 213, such as, but not limited to, x-ray and/or γ-ray radiation, such as in landmine detection. The radiation 213 (which may differ from that from 212) passes through the transparent portions of the coded aperture 218 to form a shadow of the coded aperture 218 which is detected by the detector 220.

If the object 214 is extended, it can generally be treated as comprising multiple point sources, each of which emits radiation. Each of these point-sources casts a shadow of the coded aperture 218 on to the detector 220. Thus many different shadows, corresponding to the different point sources comprising the radiation emitting object, are superimposed on the detector 220. The detector 220 provides detection signals corresponding to the energy and pattern of the emitted radiation, and the processor 222 can subsequently form an image of the object 214 based upon the shadows of the coded aperture detected by detector 220. The processor 222 can characterize the object by reconstructing a visible image of the object 214. In this embodiment, the imaging system additionally comprises a display 224 for illustrating the reconstructed object image to a user.

The detector 220 comprises a position sensitive detector capable of detecting the radiation emitted/emanating from the object 214 for recording the transmitted radiation to form a coded image. A single detector or a line detector can be used to record the spatial distribution of the transmitted emission signals by moving through the entire shadow-casting area within a plane. Preferably, the detector comprises a two-dimensional detector array, where the detection plane elements correspond to either a defined region of a continuous detector, or individual detector units spanning the entire area in which the coded aperture 218 casts a shadow.

Larger field of view can be achieved, for a given size of coded aperture 218 and camera 216, by moving the object 214 and the (mask 215 and camera 216) relative to each other and taking adjacent or slightly overlapping images in a grid pattern to form a composite image. This process is known as “tiling”.

Relative movement and concurrent use of more than one camera 216, is used in known manner to generate three-dimensional images.

A plethora of suitable detectors exist that can detect and record the coded image from the coded aperture. In the present invention, a large area high resolution detector 220, such as the flat panel X-ray detectors normally used in digital radiography, is particularly suitable. This detector 220 is capable of recording the coded image with sufficient and adequate sampling such that reconstruction artefacts due to spatial aliasing of the coded image is minimised in the digital reconstruction process.

Preferably, the detector resolution is chosen such that the minimum resolvable element of the object is sampled by the detector 220 according to the Nyquist sampling interval (viz. two samples per wavelength) to ensure that the coded image containing information relating to this desired minimum resolution of the object is not recorded as spatially aliased data. This will ensure the reconstruction procedure will not introduce aliasing artefacts into the image at least in the reconstruction of this element. In general the recoded image is not pre-filtered and indeed cannot be pre-filtered before it is recorded, and some aliasing artefacts will be present in the reconstructed image arising from elements smaller than the minimum resolution of the camera 216.

There are several factors relating to the performance of a coded aperture imaging system 210 that are preferably considered in the design and usage of a coded aperture imaging camera 216 for successful imaging. These may have conflicts and therefore compromises may be made. The factors include: the distance between object 214 and coded aperture 218; distance between coded aperture 218 and detector 220; the narrowest zone in the quantum zone plate (coded aperture 218); the intrinsic resolution of the detector 220; the wavelength of γ (gamma) rays or incident radiation from the source; the number of zones in the zone plate (coded aperture); the thickness of the coded aperture and the usable area of the detector 220.

The material from which the coded aperture 218 is constructed depends on cost, availability, fabrication constraints and energy of the radiation to be imaged. To avoid collimation it is advantageous to have coded aperture fabrication material that has a minimum thickness for a given attenuation. Preferably the opaque regions of the coded aperture 218 are completely opaque to the Y (gamma) radiation (if for use with such radiation) but a compromise may be made between opacity and thinness so that the coded aperture 218 material thickness provides about 99% attenuation of the incident radiation 213.

For example, in the case of γ(gamma) radiation from ^{99m}Tc with an energy of 140 keV, 1.5 mm of tungsten or 2 mm of lead will provide attenuation of 99%.

Prior art describes suitable practical materials for the fabrication of the coded aperture mask for use in γ (gamma) ray imaging. This requires the use of a material having the largest value of the product between the density ρ of the material and its attenuation coefficient μ at a given energy of the radiation. Thus for example, ρμ for uranium is 48.97 cm⁻¹, for platinum is 38.4 cm⁻¹, for gold is 35.9 cm⁻¹, for tungsten is 30.5 cm⁻¹, and for lead is 22.96 cm⁻¹.

Tungsten permits the fabrication of the coded aperture 218 characterised by a high attenuation at minimal thickness. However, tungsten may require specialised machining tools and stringent conditions. The quantum zone plate coded aperture 218 is provided with a support structure e.g. plate.

Other suitable materials for fabricating the coded aperture 218 include Tungsten-based alloys (composed of greater than 90% Tungsten, for example). These materials are easier to machine than pure tungsten and are commercially available.

The thickness of the coded aperture is significant in that radiation 213 from off-axis angles with respect to the transparent regions of the coded aperture 218 will be attenuated or essentially blocked leading to a blurred and incomplete shadow. This feature is referred to as “vignetting” and if not protected against will limit the coded aperture from casting complete shadows onto the detector plane. This factor is important particularly in near-field imaging where off-axis rays subtend larger angles at the entrance to the transparent regions of the coded aperture. The maximum angle from the perpendicular, θ, for incident radiation on the coded aperture for a given coded aperture material thickness (t_{ca}) and minimum aperture element width (w) is θ=tan⁻¹(w/t_{ca}).

Manufacturing constraints can place a restriction on the minimum width of the element that can be fabricated in zone plate type apertures. This restriction may also apply to other types of coded aperture known in the prior art. This practical restriction can be given by a rule-of-thumb relationship such that w≧0.25t_{ca}. An angle less than θₘₐₓ should be selected to allow a margin of safety. Compensation may be made to account for the thickness of the support plate required for the coded aperture 218.

Once the width of the narrowest zone wₘᵢₙ is known the coded aperture 218 can be selected with the appropriate number of zones with overall diameter D_{zp}.

To ensure that the coded image is formed by geometrical optics and appropriate shadows of the coded aperture are cast onto the coded image plane, then the narrowest zone should not diffract the incident radiation. To achieve this wₘᵢₙ must be much greater than λ.

The narrowest width of the opaque elements of the coded aperture 218 should be wide enough to ensure <5% penetration of γ (gamma) radiation through it, to avoid a phenomenon known as septal penetration in conventional collimator design. This is satisfied if the thickness of the smallest opaque element, t_{opq} is such that

$${t}_{opq} \geq \frac{6 {w}_{min} / μ}{{t}_{ca} - ( 3 / μ )} ,$$

where μ is the linear attenuation coefficient for the material for the appropriate energy of γ (gamma) radiation.

For a given object diameter, quantum zone plate diameter and detector size a suitable useable coded image diameter can be determined to enable the coded image to be captured within the detectable area of the detector without the need for accurate positioning/alignment of the coded image. This diameter of the coded image is denoted by S_{ci}, if tiling isn't used.

From geometrical considerations the coded image diameter S_{dD}_{_{zp}} is given by

$${S}_{{dD}_{zp}} = ( 1 + \frac{{b}_{ca}}{{a}_{ca}} ) {D}_{zp} + ( \frac{{b}_{ca}}{{a}_{ca}} ) d$$

where a_{ca}, b_{ca} & d are the distance between the object 214 and coded aperture 218, the distance between the coded aperture and coded image and the diameter of the object respectively. The first term of above equation is the projection of the coded aperture by a point source at a distance a_{ca} from the coded aperture and then second term is the magnification of the object diameter in the plane of the coded image. Preferably S_{dD}_{_{zp}}≦S_{ci}.

The object and aperture shadows are in this embodiment of equal size. Consequently the object 214 is then “matched” to the coded aperture. This matching occurs when

$$( 1 + \frac{{b}_{ca}}{{a}_{ca}} ) {D}_{zp} = ( \frac{{b}_{ca}}{{a}_{ca}} ) d .$$

The above condition then imposes a limit on the maximum diameter of the object dₘₐₓ that can be imaged on the basis of the matching condition. This diameter can be considered to be the field of view of the object 214 and is given by

$${d}_{max} \leq 0.5 * {S}_{ci} ( \frac{{a}_{ca}}{{b}_{ca}} ) .$$

A point source at the edge of the object field of view given by dₘₐₓ is designed to cast a complete shadow of the code aperture 218 onto the coded image plane. In order to prevent vignetting and to ensure that the shadow is captured by the useable detector area the object space is limited to a cone, shown in FIG. 15, with vertex a₁ from the coded aperture plane 250 with the base of the cone given by

$${d}_{max} \leq 0.5 * {S}_{ci} ( \frac{{a}_{ca}}{{b}_{ca}} )$$

and the height of this cone given by a₂ where a₁+a₂=a_{ca}, the total distance from the object to the coded aperture 218.

The theory of image formation used in coded aperture imaging is mostly well established. A brief summary of the theory of image formation is presented.

If a three dimensional object O(x,y,z), is considered and the coded aperture 218 is represented by A(p,q) and assuming the system to be space-invariant and linear, the coded image G(u,v) of the n^{th} layer of the object along the z-direction at a distance Zₙ is given by the convolution of the object, suitably scaled, with the intensity point spread function (PSF) of the coded aperture. This is represented by the expression

$$G ( u , v ) = {\sum }_{n = 1}^{m} \{ {k}_{n} {O}_{n} ( x , y ) ⊗ \text{⊗} ( 1 + {k}_{n} ) A ( p , q ) \} ,$$

where [symbol] represents two dimensional convolution and k is the ratio b_{ca}/a_{ca} where a_{ca} and bₑₐ are the object to coded aperture and coded aperture to detector (or coded image plane) distances respectively.

In this formulation, the n^{th} layer of the object Oₙ(x,y) is by definition planar and it is implicitly assumed that a plane wave emanates from this plane of the three dimensional object for the convolution representation to be valid.

This explains why all coded apertures known in the prior art succeed in imaging far-field objects, i.e. objects at a very large distance compared with the dimensions of the coded aperture where the assumption of a plane wave emanating from the object is physically realisable and therefore the convolution representation of the coded image formation is satisfied.

The artefacts arising from this incomplete convolution is present in all pre-existing coded apertures in the prior art.

By virtue of design the coded aperture 218 of this invention, is in contrast able to encode both plane and spherical waves emanating from an object in the far- or near-field respectively to satisfy the convolution representation of coded image formation. In the near-field this is achieved by projecting a spherical wave onto a planar surface in accordance with the scalar theory of diffraction.

The projection of a spherical wave on to a planar surface incorporates the obliquity factor, required by the scalar theory of diffraction to make such a theory tenable.

The reconstruction of the object O(x,y,z) can be represented by I(x,y,z) and may be performed by correlating the coded image, G(u,v), with the coded aperture, A(p,q). This is represented by the following expression:

$$I ( x , y , z ) = {\sum }_{n = 1}^{m} \{ G ( u , v ) ** A ( p , q ) \} ,$$

where ★ ★ represents two dimensional correlation and G(u,v) contains depth information of the object. In practice the image I(x,y,z) is reconstructed on a plane-by-plane basis by scaling the coded aperture A(p,q) by the appropriate magnification factor, and the image I(x,y,z) is given by the summation of all the two-dimensional image planes Iₙ(x,y) which can be expressed by the following expression:

$$I ( x , y , z ) = {\sum }_{n = 1}^{m} \{ {I}_{n} ( x , y ) \} .$$

The reconstruction of the image of the object plane at a distance given by Iₙ(x,y) is given by the following expression:

$${I}_{n} ( x , y ) = [ \begin{matrix}\{ \begin{matrix}A ( p , q ) ** \\ A ( p , q )\end{matrix} \} ⊗ ⊗ \\ {O}_{n} ( x , y )\end{matrix} ] + [ \begin{matrix}{\sum }_{\begin{matrix}j = 1 \\ j \neq m\end{matrix}}^{m} \frac{{k}_{n}}{{k}_{j}} {O}_{j} ( x , y ) ⊗ \text{⊗} \\ \{ \frac{( 1 + {k}_{n} )}{( 1 + {k}_{j} )} A ( p , q , ) ** A ( p , q ) \}\end{matrix} ]$$

If {A(p,q)★★A(p,q)}=δ(x,y), viz. a delta function, then

$${I}_{n} ( x , y ) = {O}_{n} ( x , y ) + [ \begin{matrix}{\sum }_{\begin{matrix}j = 1 \\ j \neq m\end{matrix}}^{m} \frac{{k}_{n}}{{k}_{j}} {O}_{j} ( x , y ) ⊗ \text{⊗} \\ \{ \frac{( 1 + {k}_{n} )}{( 1 + {k}_{j} )} A ( p , q , ) ** A ( p , q ) \}\end{matrix} ]$$

We see that the image of the reconstructed object plane will have artefacts arising from out-of-focus planes unless the correlation of the coded aperture for the n^{th} layer with the PSFs of all other layers, namely

$$\{ \frac{( 1 + {k}_{n} )}{( 1 + {k}_{j} )} A ( p , q , ) ** A ( p , q ) \vert$$

produces a uniform background or a uniform field of zeros in digital correlation.

If {A(p,q)★★A(p,q)}≠δ(x,y), viz. is not a delta function, then the reconstruction will be the convolution of the object with this non-ideal autocorrelation of the coded aperture and the image will contain artefacts resulting from this effect.

It should be noted that the process of shadow formation (convolution) can reverse the polarity of the coded aperture 218. In other words, a detector 220 recording intensity can make transparent areas of the coded aperture opaque and opaque areas transparent.

To satisfy the imaging requirements above G(u,v) above can be replaced by −G(u,v).

This is readily accomplished in digital imaging and reduces reconstruction artefacts resulting from using {A(p,q)★★−A(p,q)} in the reconstruction process used in prior art.

If the reconstruction is performed in a non-coherent optical correlator using photographic film as the recording media, then a contact print of G(u,v) can produce the desired outcome (see Silva & Rogers, 1975)

It is also possible to select a decoding aperture B(p,q) such that {A(p,q)★★B(p,q)}=δ(x,y). The acquisition coded aperture should preferably be binary, i.e. contain transparent and opaque regions to the incident radiation 213. In the case of the quantum zone plate it is possible in a digital image reconstruction process to replace the zeros (opaque regions) by −1, thereby constructing a dual polarity quantum zone plate. This dual polarity quantum zone plate will further reduce cross-correlation artefacts that arise due to the fact that a finite number of zones are used in a practical implementation of the quantum zone plate.

The coded aperture imaging system 210 and methods of the present invention may be particularly useful for high resolution high sensitivity imaging in nuclear medicine and beneficial for imaging small fields of view when it is possible to locate the object in the cone of illumination as described herein.

The coded aperture imaging system 210 and methods of the present invention can be used for imaging in nuclear medicine using high energy isotopes such as ¹⁸F with an energy of 511 keV and other PET isotopes such as as ¹¹C (511 keV), ¹³N (511 keV), ¹⁵O (511 keV) or ⁸²Rb (511 keV) as well as with conventional high energy isotopes such as ¹³¹I (364 keV), ⁶⁷Ga (300 keV) as well as medium energy isotopes such as ¹¹¹In (171, 245 keV), and low energy isotopes such as ^{99m}Tc (140 keV), ¹²³I(159 keV) and ¹²⁵I (27 keV).

The coded aperture imaging system 210 and methods of the present invention are also useful in three-dimensional imaging applications, such as computer-aided tomography or single photon emission computed tomography (SPECT).

In addition to nuclear medicine applications described above, the coded aperture imaging system 210 of the present invention can also be used for the detection and imaging of radiation resulting from nuclear interrogation of a target object. For example, coded aperture imaging using the aperture described herein may be useful for the detection of contraband (e.g. explosives, drugs and alcohol) concealed within cargo containers, suitcases, parcels or other objects.

In addition to nuclear medicine imaging applications and contraband detection, the principles of the present invention may prove useful for numerous additional coded aperture imaging applications using radiation from any part of the electromagnetic spectrum including materials analysis, scatter radiation detection and applications relating to the movement or flow of radiation emitting objects or material over time.

In FIG. 11 is shown a linear chirp signal 300 where the instantaneous temporal frequency varies linearly with time. Such a pulse signal is known in the prior art. In FIG. 11 it is shown that the linear chirp signal 300 comprises a series of peaks P which get progressively closer on the horizontal axis which represents time, which is of course a result of the increasing frequency.

It can be shown that a linear temporal chirp signal 300 can be derived from Fresnel's zone construction. Indeed a Fresnel zone plate can be seen to be a thresholded linear spatial chirp signal where the negative amplitudes are set to zero and alternate zones made opaque with respect to the incident radiation. This is because the instantaneous spatial frequency variation of a spatial linear chirp signal varies linearly with distance.

Referring to FIG. 12 there is shown the spatial frequency of a Fresnel zone plate against its radius. The horizontal axis depicts the radius in m and the vertical axis depicts the spatial frequency in 1/m. Line 304 shows that the relationship is entirely a linear one and therefore the Fresnel zone plate and the chirp signal can be seen as manifestations of the same construction. When the chirp signal is a temporal one, the (temporal) frequency changes with time. Spatial frequency is the inverse of the Fresnel zone plate FZP zone width ΔR where ΔR=Rₙ−Rₙ₋₁ and Rₙ is the radius of the zone in a Fresnel Zone Plate FZP.

Prior art describes the instantaneous (temporal) frequency f(t) of a linear chirp 300 where the (temporal) frequency varies linearly as a function of time given by f(t)=f₀−αt where fₒ is the start frequency and α is the chirp rate or rate of increase of frequency. A chirp signal can have a frequency increase or decrease with time sometimes known as an ‘up-chirp’ or ‘down-chirp’ respectively.

If the required chirp signal x(t) is defined by the form x(t)=cos(φ(t)), where φ(t) is the phase of the chirp signal, then this phase can be determined from the definition of instantaneous frequency which states that the instantaneous frequency f(t) is given by

$$f ( t ) = \frac{1}{2 π} \frac{d ϕ ( t )}{d t} .$$

The chirp signal x(t) can then be expressed in terms of the instantaneous frequency by

$$x ( t ) = cos \{ 2 π ( {\int }_{0}^{t} f ( τ ) d τ + ϕ ( 0 ) ) \vert ,$$

φ(ο) is the phase at time zero. In the case of a linear (Fresnel) chirp 300 the time domain form of the signal x(t) is given by

$$x ( t ) = cos \{ 2 π ( {f}_{0} + \frac{α t}{2} ) t + ϕ ( 0 ) .$$

We observe that the linear chirp signal has a quadratic phase variation.

Other forms for the variation of instantaneous frequency f(t) known in the prior art are the quadratic chirp and the logarithmic chirp given by the following formulae respectively: f(t)=f₀+αt² and f(t)=f₀α^{t}. The corresponding time domain chirp signals x(t) are given by

$$x ( t ) = cos \{ 2 π ( {f}_{0} + \frac{α {t}^{2}}{3} ) t + ϕ ( 0 ) \vert \\ and \\ x ( t ) = cos \{ \frac{2 π {f}_{0}}{{log}_{e} ( α )} ( {α}^{t} - 1 ) + ϕ ( 0 )$$

respectively.

Problems arise with using a linear chirp signal, as with Fresnel zone plates, since it does not encode a wave equation dependent amplitude as well as phase factors into the whole signal. Accordingly if, for example, a linear chirp signal 300 is used to illuminate an object and its reflectional scatter is detected by an appropriate detector, only phase information is encoded with the pulses returned to the detector by the reflected pulse. The amplitude term, as with Fresnel zones, will be unity. In order to accurately locate the object or make an image of it, both phase and amplitude should be used.

In an analogous manner to the spatial image formation case we can consider each point of the object to scatter or reflect the incident chirp signal and the image is formed by the summation (convolution) of the individual signals from each point source. Ideally a point from the source will be imaged as a point in the image but in practice a point in the image is spread into what is called its point-spread function or the autocorrelation function of the incident chirp signal x(t). The linear chirp signal 300 has an autocorrelation function with high side lobes. Thus images formed using it will have artefacts.

Direct analogues of the spatial domain chirp signals from the above temporal counterparts can be formulated to give relationships for the variation of spatial frequency f(r) as a function of distance viz., f(r)=f₀+βr where fₒ is the start frequency and β is the chirp rate or rate of increase of spatial frequency. The required linear chirp signal see FIG. 11 for an example, 300 may then be written as

$$x ( r ) = cos \{ 2 π ( {f}_{0} + \frac{β r}{2} ) r + ϕ ( 0 ) .$$

If the initial phase φ(o)=o, the signal may be referred to as a cosine chirp while if φ(o)=−π/2 it may be called a sine chirp. Note also that the spatial chirp function above is symmetrical about the vertical axis.

A Fresnel Zone Plate is a thresholded chirp signal given by

$$x ( r ) = SGN cos \{ 2 π ( {f}_{0} + \frac{β r}{2} ) r + ϕ ( 0 )$$

with the negative amplitudes of the signal set to zero and alternate zone made opaque with respect to the incident radiation.

A quantum chirp signal generated by fitting a functional relationship to the variation of spatial frequency with the radius of the quantum zone plate (see FIG. 14). This functional form represents the instantaneous spatial frequency variation as a function of distance. Using the relationship between the phase of the quantum chirp signal φ(r) and the instantaneous spatial frequency variation given by

$$f ( r ) = \frac{1}{2 π} \frac{d ϕ ( r )}{d r}$$

a quantum spatial signal of the form x(y=cos(φ(r)) can be constructed. Finally a temporal quantum chirp signal can be constructed by replacing the distance variable with time and the spatial frequency with temporal frequency.

This variation can be approximated by several functions for example by

$$f ( r ) = \frac{{a}_{ch}}{r} exp ( {b}_{ch} r ) ; f ( r ) = {a}_{ch} exp ( {b}_{ch} r ) ; f ( r ) = {a}_{ch} cosh ( {b}_{ch} r ) ;$$

$$f ( r ) = {a}_{ch} sinh ( {b}_{ch} r ) and f ( r ) = {a}_{ch} \vert 1 - exp ( {b}_{ch} r ) \vert ,$$

where a_{ch} is an amplitude term and b_{ch} is the chirp rate determined by the curve fitting procedure.

For example, the coefficients a_{ch} and b_{ch} in the spatial frequency variation as a function of distance curve given by f(r)=a_{ch} exp(b_{ch}r) can be determined by plotting logₑ(f) against distance (radius of quantum zone, r). The slope of this graph will determine the coefficient b_{ch} which is the chirp rate and the amplitude term a_{ch} will be given by a_{ch}=exp(c), where c is the intercept of the above graph. Note that b_{ch} is the ratio

$$\frac{{log}_{e} ( spatial frequency )}{radius} and . {a}_{ch} = exp {\{ {log}_{e} ( spatial frequency ) \}}_{r = 0}$$

For example, using the function f(r)=a_{ch} exp(b_{ch}r) to describe the variation of spatial frequency variation as a function of distance as an example from the list of equation given above and defining the chirp signal by the form x(r)=cos(φ(r)), where φ(r) is the phase of the chirp signal, then this phase can be determined from the definition of instantaneous frequency which states that the instantaneous frequency f(r) is given by

$$f ( r ) = \frac{1}{2 π} \frac{d ϕ ( r )}{d r} .$$

The chirp signal x(r) can then be expressed in terms of the instantaneous frequency by

$$x ( r ) = cos \{ 2 π ( {\int }_{0}^{r} f ( ξ ) d ξ + ϕ ( 0 ) ) \vert , ϕ ( 0 )$$

is the phase at distance zero. The quantum chirp in the space domain can be expressed by an equation of the form

$$x ( r ) = cos \{ 2 π ( \frac{{a}_{ch}}{{b}_{ch}} exp ( {b}_{ch} r ) ) r + ϕ ( 0 ) \vert ,$$

assuming symmetry about the vertical axis.

A quantum zone plate is a thresholded chirp signal given by

$$x ( r ) = SGN cos \{ 2 π ( \frac{{a}_{ch}}{{b}_{ch}} exp ( {b}_{ch} r ) ) r + ϕ ( 0 ) \vert$$

with the negative amplitudes of the signal set to zero and alternate zone made opaque with respect to the incident radiation.

A quantum chirp signal or pulsed signal viz. a temporal signal can be generated from the above analysis for a quantum spatial signal presented above by direct substitution of distance with time and spatial frequency with temporal frequency so that a time domain signal can be generated for example by a signal of the form

$$x ( t ) = cos \{ 2 π ( \frac{{a}_{ch}}{{b}_{ch}} exp ( {b}_{ch} t ) ) t + ϕ ( 0 ) \vert$$

where a_{ch} is an amplitude term and b_{ch} is the chirp rate and φ(o) is the phase at time zero.

Accordingly, there are benefits instead in using a chirp signal which is analogous to a quantum zone plate and uses the equations above.

A chirp signal can be generated with analogue circuitry via a voltage controlled oscillator (VCO), and a linearly or exponentially ramping control voltage. It can also be generated digitally by a digital signal processing (DSP) device and digital to analogue converters (DAC), perhaps by varying the phase angle coefficient in the sinusoid generating function.

In FIG. 13 is shown a chirp signal 310 with peaks 312 in accordance with the invention. This can be referred to as a quantum chirp signal 310. The rate of increase of frequency for the quantum chirp signal 310 is greater than that for the linear chirp signal 300. Accordingly, and as can be seen from a comparison of FIGS. 11 and 13, the peaks 312 get close together more rapidly than the peaks P of linear chirp signal 300 in the temporal direction. This is to be expected and it is directly analogous to the zones shown in FIG. 2 and FIG. 1, where quantum zones 13 get closer more rapidly than the Fresnel zones Z in the radial direction. As explained above, the relationship between radius and n and hence the peak distance and n is logarithmic.

FIG. 14 is the equivalent to FIG. 12 but for the quantum zone construction of quantum zones 13 plotting spatial frequency against radius. As shown the line 314 follows a logarithmic relationship in this case and is equal to the equation y=2088.4E^{465896x}

Such a quantum chirp signal 310 can encode amplitude and phase factors and therefore can be used to locate and image an object more accurately.

The autocorrelation function of a quantum chirp signal 310 has lower side lobes than a linear chirp signal 300. Images or spatial locations of an object will therefore have less artefacts than images from linear chirp signals 300 and the preservation of more high frequency components by the quantum chirp signal 310 will enable better location of objects and sharper and better resolved images.

1. A zoned radiation device for converging radiation of a wavelength λ to a focus at distance b, the device comprising a first set of zones and a second set of zones, wherein the first set of zones have a different characteristic to the second set and wherein the area of the zones decrease as their distance from a predetermined point increases, and one or more zone distances at which a zone of the first set with a first characteristic switches to a second zone with a second characteristic are configured such that the device can focus the radiation with wavelength λ at a distance b with an autocorrelation/point spread function that is sharper than the autocorrelation/point spread function produced by zones configured to a Fresnel zone construction.

2. A zoned radiation device according to claim 1 wherein the zone distances are radii.

3. A zoned radiation device according to claim 2 wherein the radii are radii from the predetermined point.

4. A zoned radiation device according to any preceding claim wherein the predetermined distance is the centre of the device and/or zones.

5. A zoned radiation device according to any preceding claim wherein the first and/or second set of zones comprises one or more zones and preferably a plurality of zones.

6. A zoned radiation device according to any preceding claim wherein the areas of the zones decrease from the point as a function of n where n is an integer that increases by one for each zone.

7. A zoned radiation device according to claim 6 wherein the areas of the zones vary approximately in proportion to {logₑ(n)−logₑ(n−1)}.

8. A zoned radiation device according to any preceding claim wherein the one or more zone distances are substantially close to fitting the equation {bλ logₑ(n)}^{1/2} or {b λ logₑ(n)+(λ/2 logₑ(n))²}^{1/2} measured from the centre of the zones such that the device can focus the radiation with wavelength λ at b with an auto correlation function that is significantly sharper than the autocorrelation function produced by radii configured to the Fresnel construction of (nbλ)^{1/2} or (nbλ+(n²λ²)/4)^{1/2}.

9. A zoned radiation device according to any preceding claim wherein the zones are configured to produce a built in obliquity compensation factor which is preferably approximately proportional to {logₑ (n)−logₑ(n−1)}.

10. A zoned radiation device according to any preceding claim wherein the first characteristic comprises a degree of transparency that is high relative to the second set of zones and the second characteristic comprises a degree of transparency that is low relative to the first set of zones, preferably wherein the second set of zones are opaque to the radiation of wavelength λ.

11. A zoned radiation device according to any preceding claim wherein the second set of zones comprises a refractive material which imposes a phase shift on radiation which passes through it and preferably is significantly transparent to the radiation.

12. A zoned radiation device according to claim 11 wherein the phase shift imposed on radiation of wavelength λ is ±π{logₑ(n)−logₑ(n−1)} preferably with the sign positive throughout, negative throughout or with alternating between + and − with n.

13. A zoned radiation device according to claim 11 wherein at least some of the second set of zones comprises refractive material configured so that radiation of wavelength λ is operably converged by it to arrive at the focus with the correct phase.

14. A zoned radiation device according to claim 13 wherein the device comprises a material having a refractive index η and a thickness of about τ where τ=(λ/2η){logₑ(n)−logₑ(n−1)}.

15. A zoned radiation device according to any preceding claim for converging, thermal neutrons, acoustic radiation, seismic waves, or electromagnetic radiation such as gamma or x-rays.

16. A zoned radiation device according to any preceding claim wherein the zones are configured so that the image aberration is less than the image aberration produced by zones configured to the Fresnel construction.

17. A zoned radiation device according to any preceding claim wherein the configuration of zones is derivable from a solution to a wave equation that includes phase and a non-constant amplitude.

18. A collimator or ophthalmic lens comprising the device of any preceding claim for collimating or focusing radiation.

19. A monochromatizer comprising a device of any of claims 1 to 15 and an further aperture spaced from the device at a distance of about b that operably removes unwanted wavelengths of radiation.

20. A teleconverter lenses for a compact digital cameras comprising a radiation device according to claim 16 preferably when dependent on claim 13 or 14.

21. A two-dimensional array of apertures or lenses, preferably for use in acoustic ink printing, comprising one or a plurality of devices according to any of claims 1 to 17.

22. A coded aperture comprising the device of any preceding claim for casting shadows in a plane from, and preferably not significantly diffracting, radiation of a wavelength smaller than λ.

23. A coded aperture imaging apparatus, for imaging an object, comprising an aperture according to claim 22 and one or more of external radiation source, a detector which can be sensitive to colour and/or polarization, a data processor and an image display for displaying a reconstructed image.

24. A coded aperture imaging apparatus according to claim 23 when dependent on claim 15 wherein the image may encode information based on amplitude.

25. A coded aperture imaging apparatus according to claim 23 or 24 wherein the processor is programmed to reconstruct an image of the object by using a decoding function which is preferably designed to reduce the side-lobes of the autocorrelation/point-spread-function of the coded aperture.

26. A coded aperture imaging apparatus according to claim 25 wherein the decoding function is scaled so that it operably obtains a reconstructed image of a two-dimensional slice of a three-dimensional object.

27. Apparatus according to any of claims 23 to 26 where in the detector is a flat panel detector configured to convert radiation, directly to a coded image

28. Apparatus according to any of claims 23 to 26 where in the detector is a flat panel detector configured to convert radiation, indirectly preferably by a fluorescent material in conjunction with a photo diode, to form the coded image.

29. Apparatus according to any of claims 23 to 28 configured to sequentially capture views of an object and/or that comprises a plurality of coded apertures according to claim 20 a to capture different views of the object.

30. Apparatus according to any of claims 23 to 29 wherein the processor is programmed to replace the coded image by a replacement image preferably by multiplying the values of the coded image by −1 in a digital version of the coded image or by making a contact print of the coded image, such as in use with photographic methods for recording the coded image.

31. A coded aperture system comprising apparatus according to any of claims 23 to 30 and an object wherein the detector is positioned relative to the object to receive radiation from the object within a cone of illumination, the base of the cone given approximately by
$${d}_{max} \leq 0.5 * {S}_{ci} ( \frac{{a}_{ca}}{{b}_{ca}} )$$
and the height of this cone given by a₂, where
$$+ ¿ {a}_{2} = ¿ {a}_{ca}$$
$${a}_{1} ¿$$
$$¿$$
the total distance from the object to the coded aperture, dₘₐₓ is the maximum diameter of the object, S_{ci} diameter of the coded image at the detector.

32. The use of a zoned device or imaging system according to any of claims 1 to 31 in astronomy, nuclear medicine, molecular imaging, contraband detection, land mine detection, small animal imaging, detecting improvised explosive devices and imaging of inertial confinement fusion targets and/or with an object that is anatomical and/or radioactive.

33. The use of a device according to any preceding claim for wireless applications, acoustic microscopy, and/or in concert halls for analysing and applying the acoustic response of a concert hall to music recorded in a studio.

34. A method of determining the presence of tumours comprising the step of evaluating a reconstructed image produced by using an aperture or apparatus according to any of claims 22 to 31.

35. A method of three-dimensional imaging from single projections of a coded image using a coded aperture or apparatus according to any of claims 22 to 31.

36. A method of determining the existence of contraband articles comprising the step of evaluating a reconstructed image produced by using an aperture or apparatus according to any of claims 22 to 31.

37. An off axis zoned radiation device comprising a device according to any of claims 1 to 31 wherein the zones are off axis, the centre of the device being separate form the predetermined point.

38. A zoned radiation device according to any of claims 1 to 31 wherein the zones are annular or circular

39. A 1-dimensional or linear zoned radiation device comprising a device according to any of claims 1 to 31 wherein the zone distances from a line through the predetermined point are substantially constant along each zone.

40. A non-linear chirp signal for carrying, collecting or determining data, the chirp having a frequency that increases or decreases with time, wherein the rate of increase or decrease of frequency of the chirp is configured such that the signal has an autocorrelation/impulse response function that is sharper than the autocorrelation/impulse response function produced by a linear chirp signal.

41. A non-linear chirp signal according to claim 40 wherein the configuration of the rate of increase of frequency is derivable from a solution to a wave equation that includes phase and a non-constant amplitude.

42. A non-linear chirp signal according to claim 40 or 41 wherein the image may carry or collect or determine information based on/including encoded amplitude terms.

43. A non-linear chirp signal according to any of claims 40 to 42 of a form substantially close to
$$x ( t ) = cos \{ 2 π ( \frac{{a}_{ch}}{{b}_{ch}} exp ( {b}_{ch} t ) ) t + ϕ ( 0 ) \}$$
where a_{ch} is an amplitude term and b_{ch} is the chirp rate and φ(0) is the phase at time zero, to produce a sharp autocorrelation function with small side lobes.

44. A cycle of chirp pulses according to any of claims 40 to 43 wherein the pulses have a different initial phase φ(0) from each other.

45. A signal comprising a cycle according to claim 44 and a second cycle of chirp pulses according to any of claims 30 to 33 wherein the pulses have a different initial phase φ(0) from the pulses of the first cycle.

46. A signal comprising a supercycle of the cycle of claim 44 and the second cycle of claim 45 to produce pulses, such as to invert the longitudinal magnetisation in the sample in NMR applications, and/or for detecting the signals emitted by the sample in response to inversion of the longitudinal magnetisation.

47. A method of coded aperture imaging of an object using the coded aperture or apparatus of any of claims 22 to 31

48. A method of coded aperture imaging of an object according to claim 38 comprising the step of changing the position of the object relative to the coded aperture mask and the detector to obtain an image of a cross-sectional slice of a three-dimensional object.

49. A method of producing a chirp signal or cycle comprising producing a signal or cycle according to any of claims 40 to 46 and/or the steps of constructing circles with radii approximately equal to {bλ logₑ(n)}^{1/2} or {bλ logₑ(n)+(λ/2 logₑ(n))²}^{1/2}; evaluating the distance between adjacent radii ΔRₙ=(Rₙ−Rₙ₋₁) where n=2, 3, 4, 5; plotting the reciprocal of ΔRₙ against radius Rₙ; fitting a curve to this spatial frequency vs radius variation as this functional form f(r) defines the instantaneous spatial frequency variation as a function of distance; determining the amplitude term a and the chirp rate b from curve fitting; using the relationship between the phase of the quantum chirp signal φ(r) and the instantaneous spatial frequency variation given by
$$f ( r ) = \frac{1}{2 π} \frac{d ϕ ( r )}{d r}$$
to construct a spatial signal approximately of the form x(r)=cos(φ(r)) and finally constructing a temporal chirp signal by replacing the distance variable with time and the spatial frequency with temporal frequency; preferably producing a temporal chirp of the form
$$x ( t ) = cos \{ 2 π ( \frac{{a}_{ch}}{{b}_{ch}} exp ( {b}_{ch} t ) ) t + ϕ ( 0 ) \}$$
where a_{ch} is an amplitude term and b_{ch} is the chirp rate and φ(0) is the phase at time zero.

50. A 1-dimensional or linear zoned radiation device comprising a device according to any of claims 1 to 31 wherein the zone distances comprise arcs of a circle.
